(19) United States
(12) Patent Application Publication
(10) Pub. No.: US 2006/0087057 A1
(43) Pub. Date: Apr. 27, 2006

(54) Method of making a mold for a light guide plate

(75) Inventors: Akio Koike, Chu-Nan Chen (TW); Kinju Taya, Chu-Nan Chen (TW); Chao-Pai Lee, Taichung City (TW)

Correspondence Address: PILLSBURY WINTHROP SHAW PITTMAN, LLP, P.O. BOX 10500, MCLEAN, VA, 22102, US

(73) Assignee: Main Source Technology Co., Ltd., Chu-Nan-Chen (TW)

(21) Appl. No.: 10/969,043

(22) Filed: Oct. 21, 2004

(51) Int. Cl. B28B 7/38; B05D 1/40; B29C 33/40

(52) U.S. Cl. 264/337; 427/133; 427/331; 427/402

(57) ABSTRACT

A method of making a mold for a light guide plate includes the steps of plating a soft metal layer on a roller, polishing the soft metal layer, engraving the soft metal layer to form a transferring pattern on the soft metal layer, and plating a hard metal layer on the soft metal layer.

### BACKGROUND OF THE INVENTION

1. Field of the Invention

The invention relates to a method of making a mold, more particularly to a method of making a mold for a light guide plate.

2. Description of the Related Art

Referring to FIG. 1, a conventional light guide plate 1 is formed with a plurality of ridge portions 101 at a bottom surface thereof. An incident light is reflected and diffracted through the ridge portions 101 so as to obtain a uniform brightness effect.

A mold for making the light guide plate 1 is formed with a transferring pattern corresponding to the ridge portions 101 of the light guide plate 1.

Conventionally, the transferring pattern of the mold for making the light guide plate 1 is formed by etching, sand blasting, electric discharging, cutting, etc. However, etching requires the use of an etchant, which usually results in a problem of non-uniformity in precision. As for sand blasting, it is also difficult to obtain a uniform transferring pattern on the mold by sand blasting because it can not be controlled precisely. Furthermore, like etching, electric discharging also encounters the problem of non-uniformity in precision. As shown in FIG. 2, the conventional cutting is limited to the manufacture of a mold 2 having a transferring pattern composed of V-shaped recesses 201 with identical inclined angles.

### SUMMARY OF THE INVENTION

Therefore, it is an object of the present invention to provide a method of making a mold for a light guide plate, which method is capable of making a precise transferring pattern on the mold, and which method is capable of making the mold having the transferring pattern specified according to the specific configuration of the light guide plate to be made.

According to a first aspect of this invention, a method of making a mold for a light guide plate includes the steps of:

a) plating a soft metal layer on a roller;

b) polishing the soft metal layer;

c) engraving the soft metal layer to form a transferring pattern on the soft metal layer; and

d) plating a hard metal layer on the soft metal layer.

According to a second aspect of this invention, a method of making a mold for a light guide plate includes the steps of:

a) applying a releasing agent on a roller;

b) plating a soft metal layer on the releasing agent;

c) polishing the soft metal layer;

d) engraving the soft metal layer to form a transferring pattern on the soft metal layer;

e) removing the soft metal layer from the roller;

f) flattening the soft metal layer; and

g) plating a hard metal layer on the soft metal layer.

According to a third aspect of this invention, a method of making a mold for a light guide plate includes the steps of:

a) applying a releasing agent on a roller;

b) plating a first soft metal layer on the releasing agent;

c) polishing the first soft metal layer;

d) engraving the first soft metal layer to form a first transferring pattern on the first soft metal layer;

e) applying the releasing agent on the first soft metal layer which has been engraved;

f) plating a second soft metal layer on the releasing agent applied to the first soft metal layer to form a second transferring pattern on the second soft metal layer corresponding to the first transferring pattern;

g) removing the second soft metal layer from the first soft metal layer;

h) flattening the second soft metal layer; and

i) plating a hard metal layer on the second soft metal layer.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic view of a conventional backlighting device including a conventional light guide plate;

FIG. 2 is a perspective view of a conventional mold for making a light guide plate;

FIG. 3 is a schematic sectional flow diagram of the first preferred embodiment of a method of making a mold for a light guide plate according to this invention;

FIG. 4 is a schematic perspective view showing the mold made via the first preferred embodiment and the light guide plate made using the mold;

FIG. 5 is a schematic sectional flow diagram of the second preferred embodiment of a method of making a mold for a light guide plate according to this invention;

FIG. 6 is a schematic perspective view showing the mold made via the second preferred embodiment and the light guide plate made using the mold;

FIG. 7 is a schematic sectional flow diagram of the third preferred embodiment of a method of making a mold for a light guide plate according to this invention; and

FIG. 8 is a schematic perspective view showing the mold made via the third preferred embodiment and the light guide plate made using the mold.

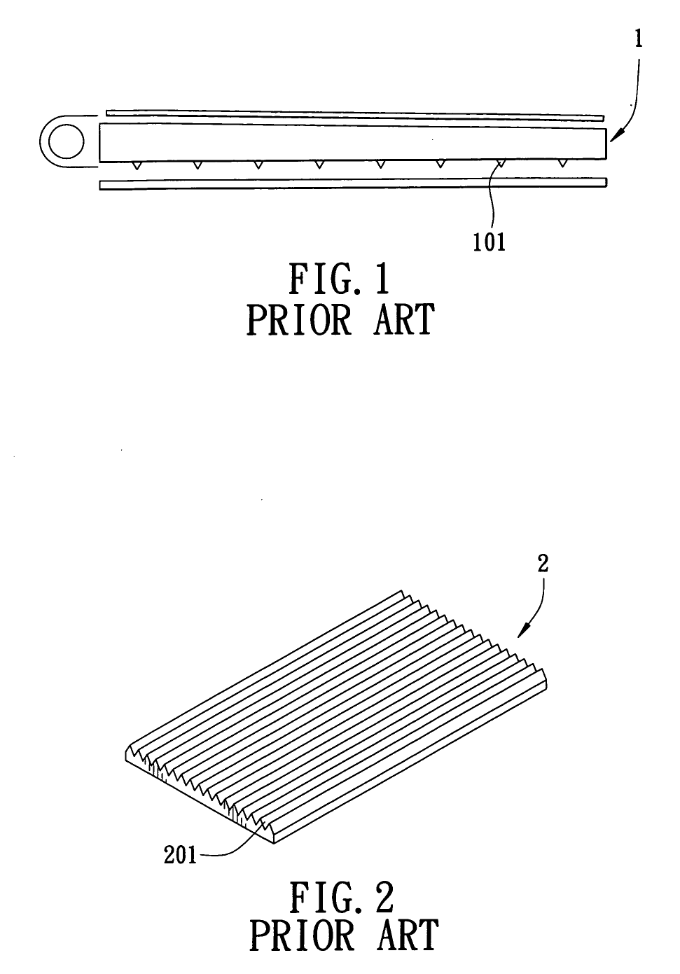

### DETAILED DESCRIPTION OF THE PREFERRED EMBODIMENTS

Before the present invention is described in greater detail, it should be noted that like elements are denoted by the same reference numerals throughout the disclosure.

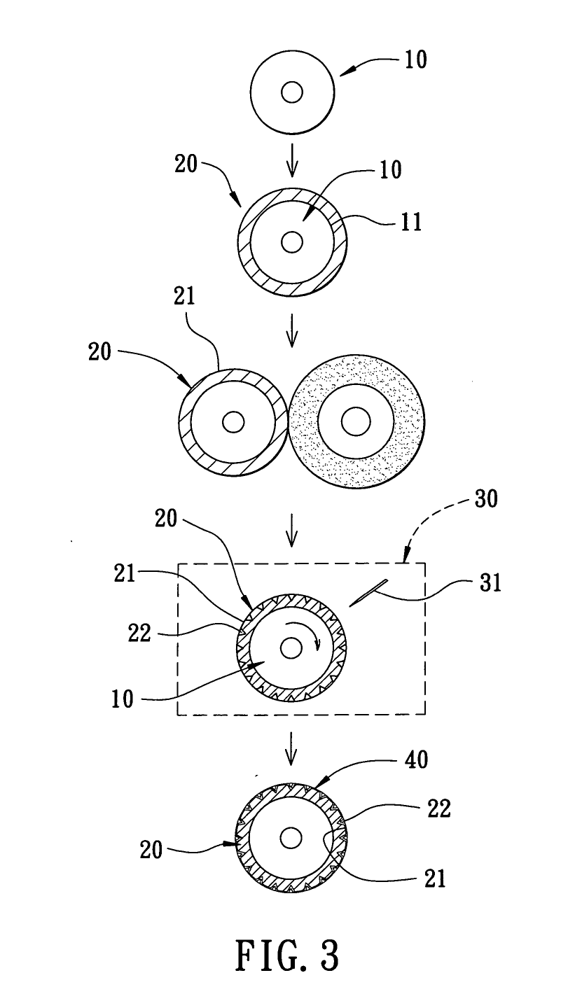

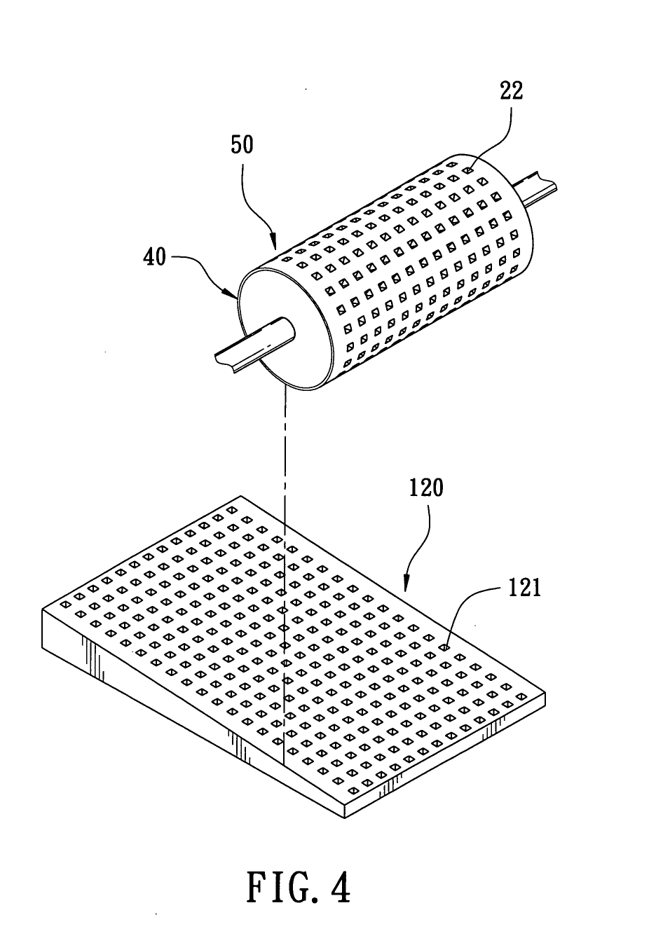

Referring to FIGS. 3 and 4, the first preferred embodiment of a method of making a mold 50 for a light guide plate 120 according to this invention is shown to include the steps of:

A) plating a soft metal layer 20 on a roller 10:

The roller 10 is provided, and the soft metal layer 20 is plated onto an outer surface 11 of the roller 10.

In this preferred embodiment, the soft metal layer 20 is made of copper, and has a thickness ranging from 100 um to 150 um.

B) polishing the soft metal layer 20:

An outer surface 21 of the soft metal layer 20 is polished using any suitable tool well known in the art (such as a grinding wheel) so that the outer surface 21 of the soft metal layer 20 has a mirror-like appearance.

C) engraving the soft metal layer 20:

A programmed electronic engraver 30 is provided, such as an electronic engraver available from OHIO Corp. of Japan. The roller 10 is mounted and rotates on the electronic engraver 30. The outer surface 21 of the soft metal layer 20 is engraved through high speed drilling of a diamond tip 31 of the electronic engraver 30 to form a transferring pattern 22 on the outer surface 21 of the soft metal layer 20. As shown in FIG. 4, the transferring pattern 22 is composed of a plurality of pyramidical recesses distributed uniformly. Notably, the density and the shape of the recesses of the transferring pattern 22 can be varied by changing the diamond tip 31 according to the specific requirements of the light guide plate 120 to be made.

D) plating a hard metal layer 40:

The hard metal layer 40 is plated on the outer surface 21 of the soft metal layer 20, which has been engraved, so as to obtain the mold 50 shown in FIG. 4. In this preferred embodiment, the hard metal layer 40 is made of a heat resistant metal, such as nickel, chromium, or an alloy thereof, and has a thickness ranging from 2 um to 3 um.

Referring to FIG. 4, the mold 50 made via the first preferred embodiment can be used to press a substrate to form the light guide plate 120 having a plurality of ridge portions 121 precisely corresponding to the recesses of the transferring pattern 22 of the mold 50.

In view of the aforesaid, the following advantages over the prior art can be achieved by this invention:

1. The outer surface 21 of the soft metal layer 20 can be engraved finely and precisely in an order of um unit by the diamond tip 31 of the programmed electronic engraver 30. Therefore, the light guide plate 120 made by the mold 50 can be formed with the ridge portions 121 precisely in an order of um unit. The light incident upon the light guide plate 120 can be reflected and diffracted in a predetermined angle through the ridge portions 121. Therefore, an optical device (such as a liquid crystal display) in which the light guide plate 120 is mounted can be improved in respect of the level and the distribution evenness of luminance.

2. Since the diamond tip 31 of the electronic engraver 30 is programmed by a computer, the density and the configuration of the recesses 22 of the transferring pattern 22 can be varied according to the specific requirements of the light guide plate 120 to be made.

3. Since the hard metal layer 40 applied on the mold 50 is heat resistant, the light guide plate 120 can be reproduced easily and precisely by the mold 50 made via the method of this invention. Therefore, the productivity of the light guide plate 120 can be improved.

In addition, it is a trend to enlarge the size of the liquid crystal display. The size of the light guide plate 120 used for the liquid crystal display can be enlarged by enlarging the size of the mold 50 so as to meet the specific requirements.

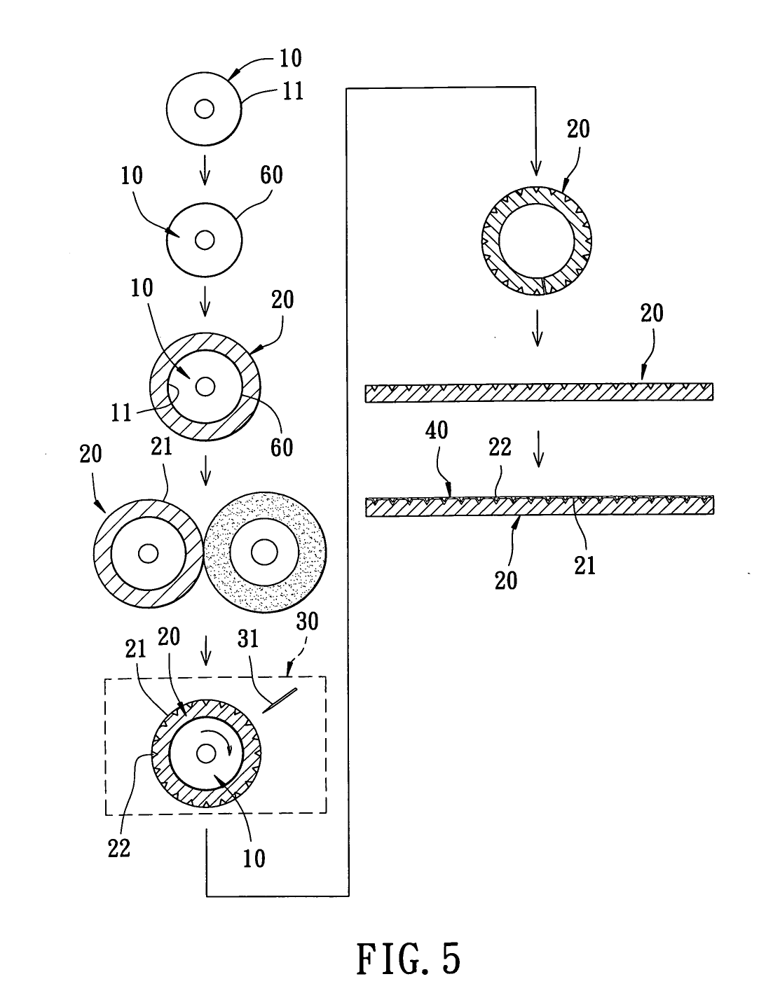

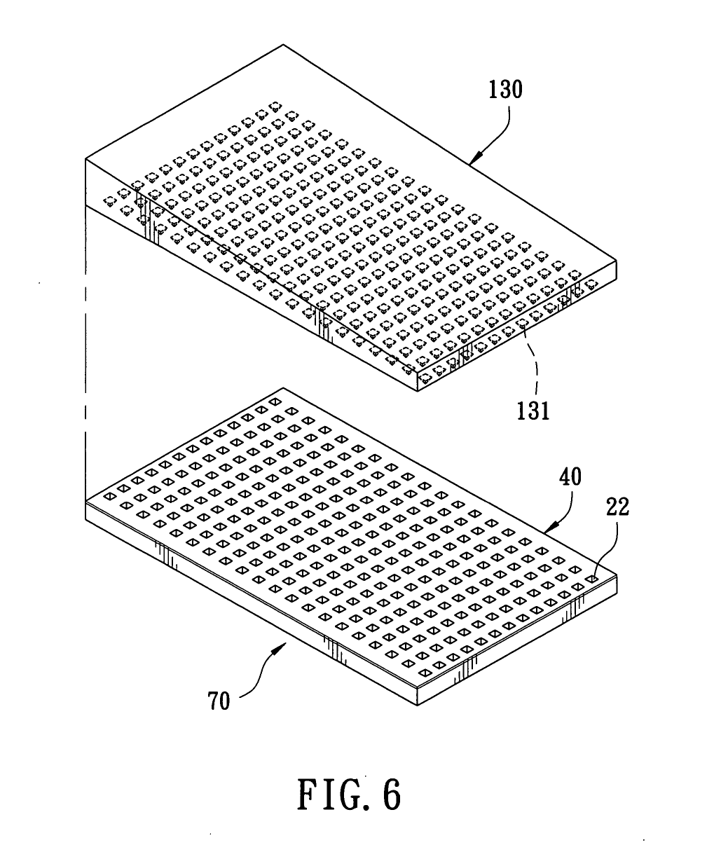

Referring to FIGS. 5 and 6, the second preferred embodiment of a method of making a mold for a light guide plate according to this invention is shown to include the steps of:

A) applying a releasing agent 60:

A roller 10 is provided, and the releasing agent 60 is applied on an outer surface 11 of the roller 10.

B) plating a soft metal layer 20:

The soft metal layer 20 is plated onto the releasing agent 60 applied on the outer surface 11 of the roller 10. In this preferred embodiment, the soft metal layer 20 is made of copper, and has a thickness of 300 um.

C) polishing the soft metal layer 20:

An outer surface 21 of the soft metal layer 20 is polished so that the outer surface 21 of the soft metal layer 20 has a mirror-like appearance.

D) engraving the soft metal layer 20:

The soft metal layer 20 is engraved in a manner substantially identical to the engraving step C) of the first preferred embodiment to form a transferring pattern 22 on the soft metal layer 20. As described in the first preferred embodiment, the density and the shape of recesses formed in the transferring pattern 22 can be varied by changing the diamond tip 31 according to the specific requirements of the light guide plate 130 to be made.

E) removing the soft metal layer 20:

The soft metal layer 20 is removed from the outer surface 11 of the roller 10.

F) flattening the soft metal layer 20:

The soft metal layer 20 is flattened, for example, on a working table (not shown).

G) plating a hard metal layer 40:

The hard metal layer 40 is plated on an outer surface 21 of the soft metal layer 20 so as to obtain the mold 70 shown in FIG. 6. In this preferred embodiment, the hard metal layer 40 is made of a heat resistant metal, such as nickel, chromium, or an alloy thereof, and has a thickness ranging from 2 um to 3 um.

Referring to FIG. 6, the mold 70 made via the second preferred embodiment can be used to press a substrate to form a light guide plate 130 having a plurality of ridge portions 121 precisely corresponding to the recesses of the transferring pattern 22 of the mold 70.

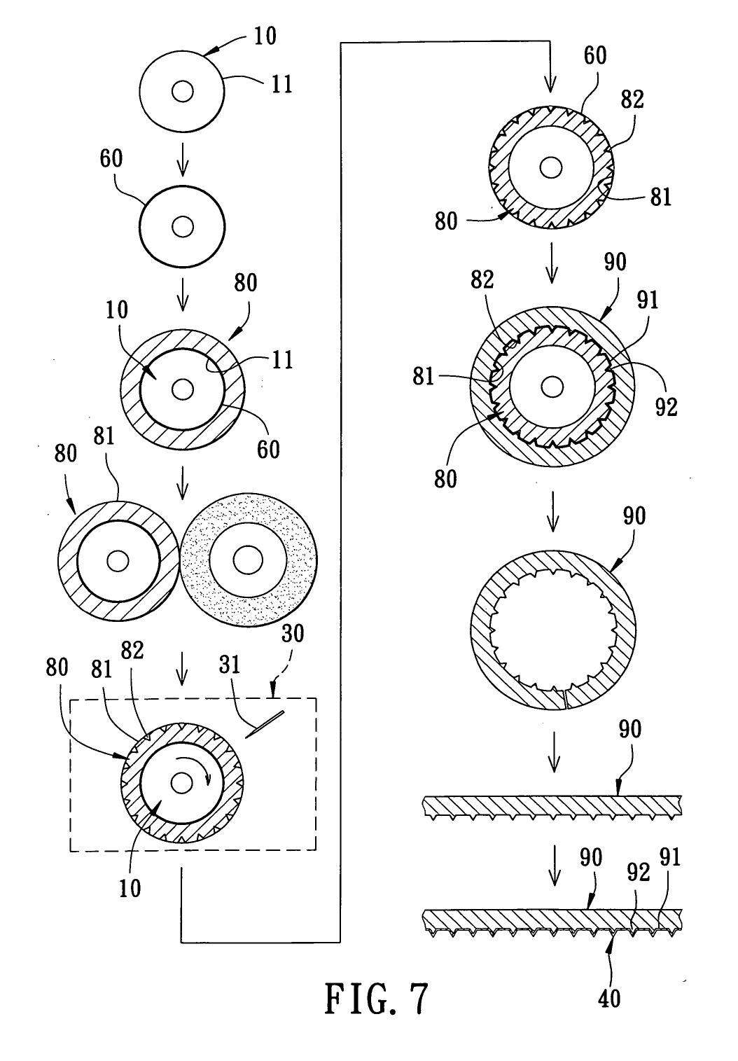

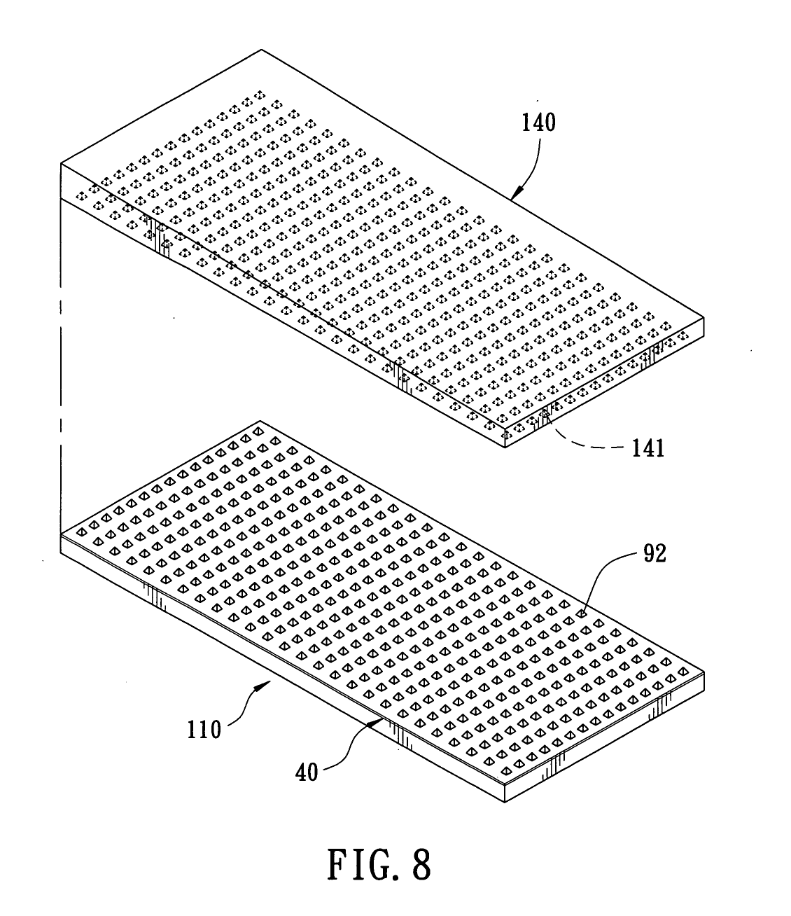

Referring to FIGS. 7 and 8, the third preferred embodiment of a method of making a mold for a light guide plate according to this invention is shown to include the steps of:

A) applying a releasing agent 60:

A roller 10 is provided, and the releasing agent 60 is applied on an outer surface 11 of the roller 10.

B) plating a first soft metal layer 80:

The first soft metal layer 80 is plated onto the releasing agent 60 applied on the outer surface 11 of the roller 10. In this preferred embodiment, the first soft metal layer 80 is made of copper, and has a thickness ranging from 100 um to 150 um.

C) polishing the first soft metal layer 80:

An outer surface 81 of the first soft metal layer 80 is polished so that the outer surface 81 of the first soft metal layer 80 has a mirror-like appearance.

D) engraving the first soft metal layer 80:

The first soft metal layer 80 is engraved in a manner substantially identical to the engraving step C) of the first preferred embodiment to form a first transferring pattern 82 on the outer surface 81 of the first soft metal layer 80. As described in the first preferred embodiment, the density and the shape of recesses formed in the first transferring pattern 82 can be varied by changing the diamond tip 31 according to the specific requirements.

E) applying the releasing agent 60:

The releasing agent 60 is applied on the outer surface 81 of the first soft metal layer 80, which has been engraved.

F) plating a second soft metal layer 90:

The second soft metal layer 90 is plated on the releasing agent 60 applied to the first soft metal layer 80 to form a second transferring pattern 92 on the second soft metal layer 90 corresponding to the first transferring pattern 82. In this preferred embodiment, the second soft metal layer 90 is made of copper, and has a thickness of 300 um.

G) removing the second soft metal layer 90:

The second soft metal layer 90 is removed from the outer surface 81 of the first soft metal layer 80.

H) flattening the second soft metal layer 90:

The second soft metal layer 90 is flattened.

I) plating a hard metal layer 40:

The hard metal layer 40 is plated on the surface 91 of the second soft metal layer 90 having the second transferring pattern 92 so as to obtain the mold 110 shown in FIG. 8. In this preferred embodiment, the hard metal layer 40 is made of a heat resistant metal, such as nickel, chromium, or an alloy thereof, and has a thickness ranging from 2 um to 3 um.

Referring to FIG. 8, the mold 110 made via the third preferred embodiment can be used to press a substrate to form a light guide plate 140 having a plurality of ridge portions 141 precisely corresponding to the recesses of the second transferring pattern 92 of the mold 110.

In the third preferred embodiment, the mold 110 having the second transferring pattern 92 corresponding to the first transferring pattern 82 can be reproduced easily and precisely by repeating the steps E) to I). Furthermore, if needed, the engraved first soft metal 80 remaining on the roller 10 after the step G) of the third preferred embodiment can be further processed by the steps E) to G) of the second preferred embodiment to obtain a mold having the first transferring pattern 82.

Notably, although it is illustrated in the preferred embodiments that the molds 50, 70, 110 are suitable for making the light guide plates 120, 130, 140, the present invention can also be used for making a mold suitable for making a diffusion sheet or a condensing sheet.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

We claim:

1. A method of making a mold for a light guide plate, comprising the steps of:
a) plating a soft metal layer on a roller;
b) polishing said soft metal layer;
c) engraving said soft metal layer to form a transferring pattern on said soft metal layer; and
d) plating a hard metal layer on said soft metal layer.

2. The method as claimed in claim 1, wherein said soft metal layer is made of copper.

3. The method as claimed in claim 1, wherein said soft metal layer has a thickness ranging from 100 um to 150 um.

4. The method as claimed in claim 1, wherein the step c) is conducted using an electronic engraver, said roller being mounted on said electronic engraver.

5. The method as claimed in claim 1, wherein said hard metal layer is made of a heat resistant metal.

6. The method as claimed in Clam 1, wherein said hard metal layer has a thickness ranging from 2 um to 3 um.

7. The method as claimed in claim 5, wherein said heat resistant metal is selected from a group consisting of nickel and chromium.

8. A method of making a mold for a light guide plate, comprising the steps of:
a) applying a releasing agent on a roller;
b) plating a soft metal layer on said releasing agent;
c) polishing said soft metal layer;
d) engraving said soft metal layer to form a transferring pattern on said soft metal layer;
e) removing said soft metal layer from said roller;
f) flattening said soft metal layer; and
g) plating a hard metal layer on said soft metal layer.

9. The method as claimed in claim 8, wherein said soft metal layer is made of copper.

10. The method as claimed in claim 8, wherein said soft metal layer has a thickness of 300 um.

11. The method as claimed in claim 8, wherein the step d) is conducted using an electronic engraver, said roller being mounted on said electronic engraver.

12. The method as claimed in claim 8, wherein said hard metal layer is made of a heat resistant metal in a thickness ranging from 2 um to 3 um.

13. The method as claimed in claim 8, wherein said heat resistant metal is selected from a group consisting of nickel and chromium.

14. A method of making a mold for a light guide plate, comprising the steps of:
a) applying a releasing agent on a roller;
b) plating a first soft metal layer on said releasing agent;
c) polishing said first soft metal layer;
d) engraving said first soft metal layer to form a first transferring pattern on said first soft metal layer;
e) applying said releasing agent on said first soft metal layer which has been engraved;
f) plating a second soft metal layer on said releasing agent applied to said first soft metal layer to form a second transferring pattern on said second soft metal layer corresponding to said first transferring pattern;
g) removing said second soft metal layer from said first soft metal layer;
h) flattening said second soft metal layer; and
i) plating a hard metal layer on said second soft metal layer.

15. The method as claimed in claim 14, wherein said first soft metal layer is made of copper in a thickness ranging 100 um to 150 um.

16. The method as claimed in claim 14, wherein said second soft metal layer is made of copper in a thickness of 300 um.

17. The method as claimed in claim 14, wherein the step d) is conducted using an electronic engraver, said roller being mounted on said electronic engraver.

18. The method as claimed in claim 14, wherein said hard metal layer is made of a heat resistant metal in a thickness ranging from 2 um to 3 um.

19. The method as claimed in claim 18, wherein said heat resistant metal is selected from a group consisting of nickel and chromium.
